(19) United States
(12) Patent Application Publication
(10) Pub. No.: US 2023/0366843 A1
(43) Pub. Date: Nov. 16, 2023

(54) METHOD AND SYSTEM FOR MONITORING OBJECTS AND EQUIPMENT BY THERMAL IMAGING AND DATA ANALYSIS

(71) Applicant: IDLETECHS AS, Trondheim (NO)

(72) Inventors: Harald Martens, Trondheim (NO); Torbjorn Pedersen, Trondheim (NO); Andreas Simskar Wulvik, Trondheim (NO)

(21) Appl. No.: 18/029,642

(22) PCT Filed: Sep. 30, 2021
(86) PCT No.: PCT/EP2021/076948

§ 371 Date: Mar. 30, 2023

(30) Foreign Application Priority Data
Oct. 6, 2020 (GB) 2015843.2

(51) Int. Cl. G01N 25/72; G06T 7/00

(52) U.S. Cl. CPC G01N 25/72; G06T 7/001; G01J 2005/0077

(57) ABSTRACT

The invention provides a method of and system for a method of monitoring an object using thermal video data. The method comprises capturing thermal video images of a scene comprising the object using one or more thermal imaging cameras, and outputting a thermal video data stream to a processing apparatus. In the processing apparatus, the thermal video data stream is processed by performing a multivariate analysis of the thermal video data stream to generate one or more models of the behaviour of the object. The one or more models includes modelling of temporal development of a thermal signature of the object, and modelling of covariation of the thermal signature between different parts or regions of the scene. The processing comprises establishing one or more normal states of the object using observed data from the thermal video data stream and the one or more models, and comparing observed data from the thermal video data stream with the one or more normal states of the object to determine whether the object is a known condition or an unknown condition. An output signal from the processing apparatus if the object is determined to be in an unknown condition.

The present invention relates to a method and/or system for monitoring objects and equipment using thermal images over time, and in particular to a method and/or a system for monitoring objects and equipment by the acquisition of thermal images describing the thermal properties (thermal signatures) of an object over time, and analysis of data derived from the thermal images to identify changes or developments which are indicative of physical properties including faults and/or process conditions. An aspect of the invention relates to a method for analysing the condition history of objects and equipment over time. Aspects of the invention may be used to create a fault library for objects or equipment. The invention has application to the monitoring of objects and equipment including but not limited to engines, pumps, electrical equipment, containers, vessels, ovens, furnaces, reactors, heating and cooling systems, and pipes, as well as monitoring and/or state estimation of processes taking place in or otherwise utilising such objects and equipment.

### BACKGROUND TO THE INVENTION

Condition monitoring of objects and equipment is conventionally carried out using manual inspection techniques. Typically, handheld sensors such as thermal cameras or thermocouples are used to inspect objects at intervals (for example, every 6 months), with manual analysis of changes to the observed spatial distribution of heat. While such techniques are capable of detecting large shifts in heat distribution or leakages, there are limits to the points of interest that can be inspected, and the monitoring is only sensitive to the conditions during the period of observation. These methods do not detect past temporary conditions that could lead to issues with the objects and equipment in the future, and do not provide information about the cumulative condition history of the equipment.

Thermal video real-time monitoring of equipment has also been used, and enables recording and inspection of selected video sequences by operators watching video screens to identify changes in condition. However, such approaches make it difficult to capture dynamic changes in the system, and it is difficult to know where to check video sequences. Temporary conditions can easily be missed by the operators, and it is difficult to derive information about cumulative condition history of the equipment such as thermal stress and/or thermal strain over time.

Real-time monitoring using thermal video is currently used most effectively in the detection of specific known situations, such as very high temperatures, and has the potential to detect dangerous conditions or incidents. Analysis of the thermal video may include the plotting of data over time for a few selected key areas being monitored, to see the development of the situation at those selected key areas. However, the data collected and analysed is heavily influenced by process and ambient conditions, and it becomes very difficult to detect slow changes outside of the key areas, or to represent and understand new (i.e. previously unknown) situations.

Chinese patent publication number CN 110139069 A discloses a transformer substation thermal imaging temperature measurement monitoring system. The system comprises an image information acquisition subsystem, and hardware and software for processing the acquired image information. The system applies unspecified big data analysis methods to produce alarm notifications based on thresholds.

European patent publication number EP 3260851 A1 discloses a machine condition monitoring system that uses infrared cameras for anomaly detection. The system uses models to map 2D data to 3D for 3D thermography, and records changes of images over time. The system uses an expert system and thresholds to detect anomalies.

International patent publication number WO 2018/111116 describes a general approach to processing large amounts of multidimensional data, using multivariate analysis and pattern recognition techniques to generate self-developing models. The technique can be used generally in system monitoring applications and for compressed, efficient transmission of data files.

There exists a need for automated solutions to accurately monitor the thermal signature of objects, equipment and processes, and changes to the thermal signature over time without reliance on fixed alarm levels.

### SUMMARY OF THE INVENTION

It is amongst the aims and objects of the invention to provide a method and/or system for method and/or system for monitoring objects and equipment using thermal images which obviates or mitigates one or more drawbacks or disadvantages of available thermal imaging monitoring systems, including those referred to above.

In particular, one aim of an aspect of the invention is to provide a method and/or system for monitoring objects and equipment using thermal images that has reduced sensitivity, or is insensitive, to process and ambient conditions, view angles and distance to the measured object.

Another aim of an aspect of the invention is to provide a method and/or system that has an improved ability to detect new and unanticipated conditions or situations.

Another aim of an aspect of the invention is to provide a method and/or system that is flexible in its application in a range of different monitoring scenarios without a high level of pre-configuration or initialization, and in particular without reliance on a fault library.

Another aim of an aspect of the invention is to provide a method and/or system that is sensitive to small and/or temporary changes, and is capable of providing information relating to condition history, such as thermal stress or thermal strains experienced over time.

According to a first aspect of the invention, there is provided a method of monitoring an object using thermal video data, the method comprising:
Capturing thermal video images of a scene comprising the object using one or more thermal imaging cameras, and outputting a thermal video data stream to a processing apparatus;
In the processing apparatus, processing the thermal video data stream by:
   performing a multivariate analysis of the thermal video data stream to generate one or more models of the behaviour of the object, the one or more models including modelling of temporal development of a thermal signature of the object, and modelling of covariation of the thermal signature between different parts or regions of the scene;
   generating modelled data from the one or more models;
   establishing one or more normal states of the object using observed data from the thermal video data stream and the one or more models;
   comparing modelled data with the one or more normal states of the object to determine whether the object is a known condition or an unknown condition; and
Generating an output signal from the processing apparatus if the object is determined to be in an unknown condition.

The modelled data may comprise a compressed thermal video data sequence. The method may comprise using the one or more models to represent observed data from the thermal video data in a subspace, the subspace being lower dimensional than the thermal video data stream.

The method may comprise inputting process data into the processing apparatus, the process data relating to a process utilising the object, and incorporating the process data into the one or more models.

The method may comprise inputting simulation data into the processing apparatus, the simulation data relating to an estimation of the internal state of the object, and incorporating the simulation data into the one or more models.

The method may comprise outputting one or more model features from the processing apparatus, and storing the model features in the data storage apparatus. The model features may comprise loadings used in the model, or other model features that would enable the real-time data to be reproduced to a defined degree of precision from the modelled data.

The method may comprise extending the observed thermal images with additional spatiotemporal representations of the data, which may convert the single-channel measurement video into a multi-channel or multispectral measurement video.

The method may comprise storing uncompressed data from the thermal video data sequence in the data storage apparatus. For example, uncompressed data may be stored from a time T at which an unknown condition of the object is detected, and/or a time period leading up to the time T, and/or a time period following the time T.

The method may comprise, during a learning phase, establishing one or more initial normal states using observed data from the thermal video data stream and the one or more models. Preferably, establishing one or more normal states of the objects comprises updating the one or more initial normal states during a monitoring phase, using the observed data from the thermal video data stream and the one or more models.

The method may comprise updating the one or more models, which may comprise one or more of: adding more loadings (orthogonal or non-orthogonal) to the existing set of models, adding new models to represent certain conditions, or changing loadings of the models.

The method may comprise generating an alarm signal to an operator from the output signal, which alarm signal may indicate the detection of an unknown condition of the objects.

The method may comprise transmitting a signal that the object is determined to be in an unknown condition to a user interface. The method may comprise operator verification of the unknown condition of the object as a normal state or an abnormal state.

The method may comprise categorising and/or labelling the abnormal state with a fault label. This may enable recognition of abnormal state in future operations, thereby enabling fault identification.

According to a second aspect of the invention, there is provided a method of analysing thermal video data, the method comprising:
Receiving in a processing apparatus a thermal video data stream, the thermal video data stream comprising a sequence of thermal video images of a scene comprising an object captured using one or more thermal imaging cameras;
In the processing apparatus, processing the thermal video data stream by:
   performing a multivariate analysis of the thermal video data stream to generate one or more models of the behaviour of the object, the one or more models including modelling of temporal development of a thermal signature of the object, and modelling of covariation of the thermal signature between different parts or regions of the scene;
   generating modelled data from the one or more models;
   establishing one or more normal states of the object using observed data from the thermal video data stream and the one or more models;
   comparing modelled data with the one or more normal states of the object to determine whether the object is a known condition or an unknown condition; and
Generating an output signal from the processing apparatus if the object is determined to be in an unknown condition.

Embodiments of the second aspect of the invention may include one or more features of the first aspect of the invention or its embodiments, or vice versa.

According to a third aspect of the invention, there is provided a method of processing thermal video data, the method comprising:
Receiving in a processing apparatus a thermal video data stream, the thermal video data stream comprising a sequence of thermal video images of a scene comprising an object captured using one or more thermal imaging cameras;
In the processing apparatus, processing the thermal video data stream by:
   Generating modelled data from the thermal video data stream using one or more models, the one or more models including modelling of temporal development of a thermal signature of the objects, and modelling of covariation of the thermal signature between different parts or regions of the objects;
   Outputting the modelled data from the processing apparatus; and
   Storing the modelled data to a data storage apparatus.

The modelled data may comprise a compressed thermal video data sequence. The method may comprise using the one or more models to represent observed data from the thermal video data in a subspace, the subspace being lower dimensional than the thermal video data stream.

The method may comprise outputting one or more model features from the processing apparatus, and storing the model features in the data storage apparatus. The model features may comprise loadings used in the model, or other model features that would enable the real-time data to be reproduced to a defined degree of precision from the modelled data.

The method may comprise storing uncompressed data from the thermal video data sequence in the data storage apparatus. For example, uncompressed data may be stored from a time T at which an unknown condition of the object is detected, and/or a time period leading up to the time T, and/or a time period following the time T.

Embodiments of the third aspect of the invention may include one or more features of the first or second aspects of the invention or their embodiments, or vice versa.

According to a fourth aspect of the invention, there is provided a method of assessing the thermal load of an object from thermal video images, the method comprising:
Receiving in a processing apparatus a data set from a data storage apparatus, wherein the data set is generated according to the method of the third aspect of the invention;
In the processing apparatus, analysing the data set by:
   performing an analysis of thermal trends representing the thermal load of the system to estimate the total thermal load over a time interval; and
   issuing an output signal if total thermal load exceeds a predefined limit or has increased by more than a predefined amount over a specified time window.

As used herein, the term “thermal load” is used to mean the effects on an object or a part of an object from temperature changes (for example the size, rate, and/or frequency of temperature changes), and/or the effects on an object or a part of an object due to periods of operation (which may be steady) at temperatures outside of the normal operating envelope of the object. These effects may be referred to as thermal stress and thermal strain respectively. It will be appreciated that the method can be used to quantify thermal strain effects due to temperature changes, thermal strain effects due to operating for long periods at temperatures outside of an equipment envelope, or combinations of these effects.

The method may comprise generating a representation of the total thermal load, and transmitting the representation to a user interface.

The method may comprise comparing the estimated total thermal load over the time interval with an estimated total thermal load over an earlier time window. The method may comprise issuing an output signal if the estimated total thermal load has increased by more than a predefined amount from the estimated total thermal load over the earlier time window.

The method may be implemented in a system comprising one or more APIs, and the method may comprise exporting thermal load data to one or more third party or external software system. The method may comprise exporting thermal load data to, for example, an insurance company or certification agency for verification of system integrity.

Embodiments of the fourth aspect of the invention may include one or more features of the first to third aspects of the invention or their embodiments, or vice versa.

According to a fifth aspect of the invention, there is provided a method of assessing the thermal load of an object from thermal video images, the method comprising:
Receiving in a processing apparatus a thermal video data stream, the thermal video data stream comprising a sequence of thermal video images of a scene comprising an object captured using one or more thermal imaging cameras;
In the processing apparatus, processing the thermal video data stream by:
   performing a multivariate analysis of the thermal video data stream to generate one or more models of the behaviour of the object, the one or more models including modelling of temporal development of a thermal signature of the object, and modelling of covariation of the thermal signature between different parts or regions of the scene;
   generating modelled data from the one or more models;
   performing an analysis on the modelled data of thermal trends representing the thermal load of the system to estimate the total thermal load over a time interval; and
   issuing an output signal if the total thermal load exceeds a predefined limit or has increased by more than a predefined amount over a specified time window.

Embodiments of the fifth aspect of the invention may include one or more features of the first to fourth aspects of the invention or their embodiments, or vice versa.

According to a sixth aspect of the invention, there is provided an apparatus configured to carry out the methods of any preceding aspect of the invention.

Embodiments of the sixth aspect of the invention may include one or more features of the first to fifth aspects of the invention or their embodiments, or vice versa.

According to a seventh aspect of the invention, there is provided a computer readable medium carrying computer executable instructions capable of enabling a processing apparatus to perform the methods of any of the first to fifth aspects of the invention.

Embodiments of the seventh aspect of the invention may include one or more features of the first to sixth aspects of the invention or their embodiments, or vice versa.

### BRIEF DESCRIPTION OF THE DRAWINGS

There will now be described, by way of example only, various embodiments of the invention with reference to the drawings, of which:

FIG. 1 is a schematic representation of a thermal video monitoring system in accordance with an embodiment of the invention;

FIG. 2 is a block diagram schematically representing functional components of a thermal video monitoring system and methodology according to an embodiment of the invention;

FIG. 3 is a flow diagram representing steps of a thermal video data analysis method according to an embodiment of the invention;

FIG. 4 is a flow diagram representing steps of a thermal video data monitoring method used in a preferred embodiment of the invention;

FIG. 5 is a flow diagram representing steps of a method of generating a fault library according to an embodiment of the invention; and

FIG. 6 is a flow diagram representing steps of a thermal load estimation method according to an embodiment of the invention.

### DETAILED DESCRIPTION OF PREFERRED EMBODIMENTS

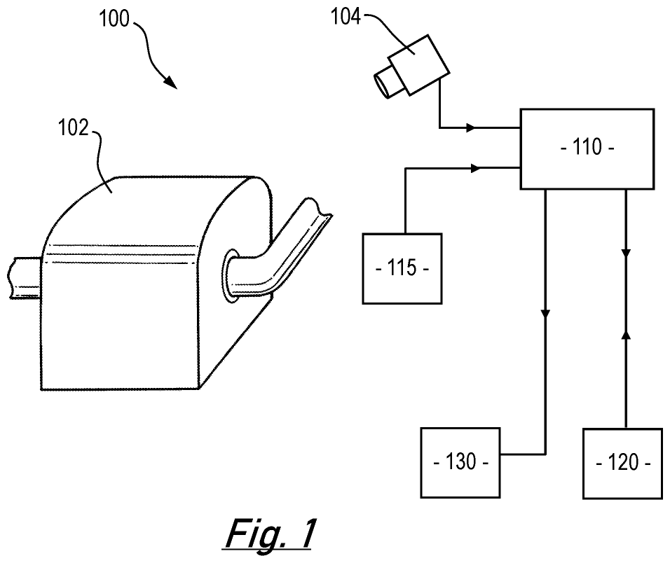

Referring firstly to FIG. 1, there is shown generally at 100, a thermal video monitoring system for an object or equipment 102. The system 100 comprises a thermal video camera 104 with a field of view directed at a scene in which the object 102 to be monitored is located. In this example, the object 102 is a chemical reactor in an industrial process, and includes associated pipework. The thermal video camera 104 is in communication with a processing apparatus 110, which in turn is in communication with a user interface 120 and an alarm system 130. The camera is located to passively capture images from the same scene and objects over a monitoring operation. Although a single thermal video camera 104 is shown in FIG. 1, the system may include two or more thermal video cameras. Multiple cameras may for example enable monitoring of a large scene, the same scene or object from different views or to provide higher resolution imaging, different objects within a scene, or to provide data redundancy.

The thermal video camera (or cameras) operates as thousands of individual temperature sensors, and generates a set of high-dimensional temperature measurements (one corresponding to each pixel in the camera sensor module) in a thermal video data stream. The camera transmits the data stream to the processing apparatus 110, which receives and processes the data using the techniques described below. The camera may transmit data to the processing apparatus via data transmission cables or wirelessly, using any suitable data transmission protocols. In a typical implementation, thermal video data is transmitted to the processing module multiple times a second, providing a sequence of spatiotemporal temperature meshes of the scene and the objects in real-time. Consequently, both the spatial distribution of heat over the object and its temporal development are measured.

The processing apparatus 110 stores and processes the data using software modules. The processing apparatus may be a computer or processing cluster local to the camera, for example within the industrial setting of the object 102. Alternatively, the processing apparatus may be remote from the camera, in which case the data may be transmitted to the remote location over a WAN or other communications network via a local computer with network access or another gateway unit. The remote processing apparatus may be a remotely located computer or a cloud-based processing cluster, and it will be appreciated that within the scope of the invention, the processing apparatus and steps performed on that apparatus may be in a jurisdiction other than that in which the camera and object are located.

The processing of the data includes data-driven modelling to establish object baselines and normal states of thermal signature of an object, and deviation and trend analysis to track how the signatures change over time. The processing is customised for real-time analysis of thermal video streams, and comprises multivariate analysis that models simultaneous changes between many inputs and outputs, as will be described below.

The user interface 120 is a web-based used interface, served by a set of services to enable an operator of the system to visualise and inspect events, models, data, trends and changes over time. The user interface 120 may provide visualisations of the thermal signature of the objects in real-time, and/or visualisations of changes, trends, historical situations and detected unknown conditions. The user interface also enables an operator to call up additional information or data, analyse a particular situation or condition, inputting data, and general system administration. The operator is able to view alarms, input interpretation of alarms, view and update models, carry out audits of changes to the system, and view real-time imaging.

The alarm system 130 provides the system with the capability to generate alarm signals, corresponding to unknown conditions or identified alarm conditions, separately from the user interface 120, for example in the location of the object 102 or in another selected location. The alarm signals, which may be visible, audible, or both, are output from the processing apparatus 110, and are generated automatically from the system, optionally after confirmation from an operator that the detected condition requires the generation of an alarm signal.

The system 100 optionally comprises a process interface module 115, which enables a set of process data to be input to the system. The process data are measurements and control data relating to the process taking place in the object, the ambient conditions, human interventions, the expected visual appearance, and/or other direct measurements. This facilitates modelling and alarm generation in the context of the process taking place in the object, improving robustness of the system to disturbances, and improving fault identification and fault detection. If process measurements and/or control data is available, these measurements can be extended to include information about the expected system condition, the ambient conditions, and to include other direct measurements.

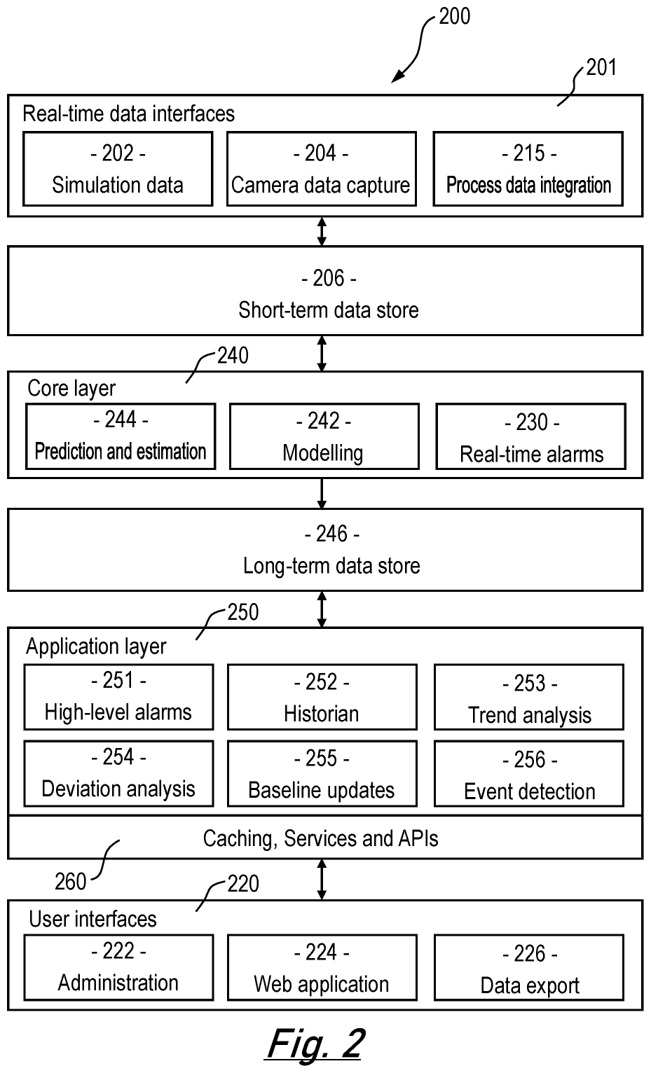

FIG. 1 and the foregoing description are a simplified representation of an embodiment of the invention to illustrate the principles of the invention. Further details of preferred and optional features are described with reference to FIGS. 2 to 6.

FIG. 2 is a block diagram schematically representing functional components of a thermal video monitoring system and methodology according to an embodiment of the invention. The system, generally shown at 200, comprises functional modules implemented in hardware and software system components. Real-time data interfaces 201 include a thermal capture data interface 204 and a process data integration interface 215 (functionally similar to interface 115 described with reference to FIG. 1). A simulation data interface 202 enables data to be input from simulation models of the behaviour of the object 102 and/or the process utilising the object. The simulation models can be fitted to the measurements (for example via faster multivariate meta-models), to include estimates of the internal state of known variation types in the object, and to discover and parameterize new, unknown variation types in the object. Open Platform Communication (OPC) Data Access and OPC Unified Architecture are examples of suitable interfaces. Short term data store 206 is used to gather the input data.

Optionally, the system includes an image extension module (not shown), in which additional spatiotemporal representations can be used to further extend the input to create a multispectral video system. The image extensions can include for example derivative images, difference images, or smoothed images in the spatial and/or temporal domains. The image extensions further extend the capability of the system to model spatiotemporal patterns by enriching the measurement data.

In a core layer 240, the system comprises a prediction and estimation module 244. The prediction and estimation module 244 uses prediction and multivariate calibration models to map between the observed temperatures (observed by the sensor), to more accurate representations of the object surface temperatures, or to estimates of internal temperature. The multivariate calibration model may e.g. be generated off-line, based on pixel-weighted Partial Least Squares regression and non-linear or local extensions thereof, or on other data-driven machine learning methods. The calibration models may later be updated as needed, possibly combined with data about the surface property of the object (known 3D geometry and known material type). Conversely, the discrepancies between the expected and observed thermal image may give new information about the object's actual 3D geometry and material type. With inclusion of an object simulator, these temperatures can be used as boundary conditions to estimate the process condition and state inside of the observed object, where such relationships exist. One can also use spatiotemporal camera- or object induced motion and/or thermal changes together with models to forecast the next expected thermal image This simulation information may be used for filling in missing thermal image elements in e.g. temporarily occluded areas or due to missing frames.

The core layer also comprises a software module 242 for performing multivariate analysis of the thermal video data stream to generate one or more models of the behaviour of the object. The models are data-driven (from the thermal video data stream), and include modelling of the temporal development of a thermal signature of the object, as well as covariation of the thermal signature between different parts or regions of the objects. The modelling includes compressing the high-dimensional thermal video data by representation of the observed data in a lower-dimensional subspace. The scene imaged by the thermal camera may be split spatially or segmented into different objects or different regions, which may be modelled jointly and/or separately. This splitting may be based on prior knowledge about the object(s) that the camera depicts (for example, similar to Partial Least Squares (PLS) path modelling), and/or may be based on systematic spatiotemporal change patterns in the subspace models summarizing the thermal camera data stream, (similar to Hierarchical Cluster-based PLS regression (PLSR)). The segmentation may be performed in the time domain, in the spatial image domain and/or in the subspace pattern domains of scores, loadings and residuals. The analysis of the individual data streams thus arising may be based on a hierarchy of local bilinear modelling. These local data models may be inter-related, e.g. via their spatial and/or temporal parameters (loadings and scores), by multiblock, multimatrix or multi-way factor analytical and regression methods (e.g. multiblock Principal Component Analysis (PCA) and PLSR, Sequential and Orthogonalized PLS (SO-PLS), PLS path analysis, Support Vector Machine (SVM) processing, Artificial Neural Network (ANN) processing, regression trees and nonlinear extensions thereof).

The compressed data is transmitted to long-term data storage module 246.

Module 230 enables the generation of alarm signals corresponding to the detection of unknown conditions or identified alarm conditions in the thermal video data stream, by comparison of observed data with established normal states of the object in real-time. Full-resolution real-time data relating to the detection of an unknown condition or anomaly is transmitted to the long-term data storage 246 with the compressed data.

A set of application modules is provided in an application layer 250. The application modules include a module 251 for generating high-level alarms based on analysis of the compressed data. In one example, historical data is analysed to quantify cumulative effects on the object over the history of the monitoring period, such as thermal load. High level alarms may be generated from trend analysis (253) or deviation analysis (254), and generally in response to detection of the occurrence of object- or process-events (256). A baseline update module 255 allows updates to be made to the normal states or baselines, automatically and/or in response to operator input after changes in the system and detection of possible baseline changes have been reported. Insights generated from the application modules are recorded in the long-term storage module 246.

System module 260 comprises caching functionality, services including access control, and APIs to enable interaction between administration (222), web application (224) and data/model export (226) components of a user interface 220.

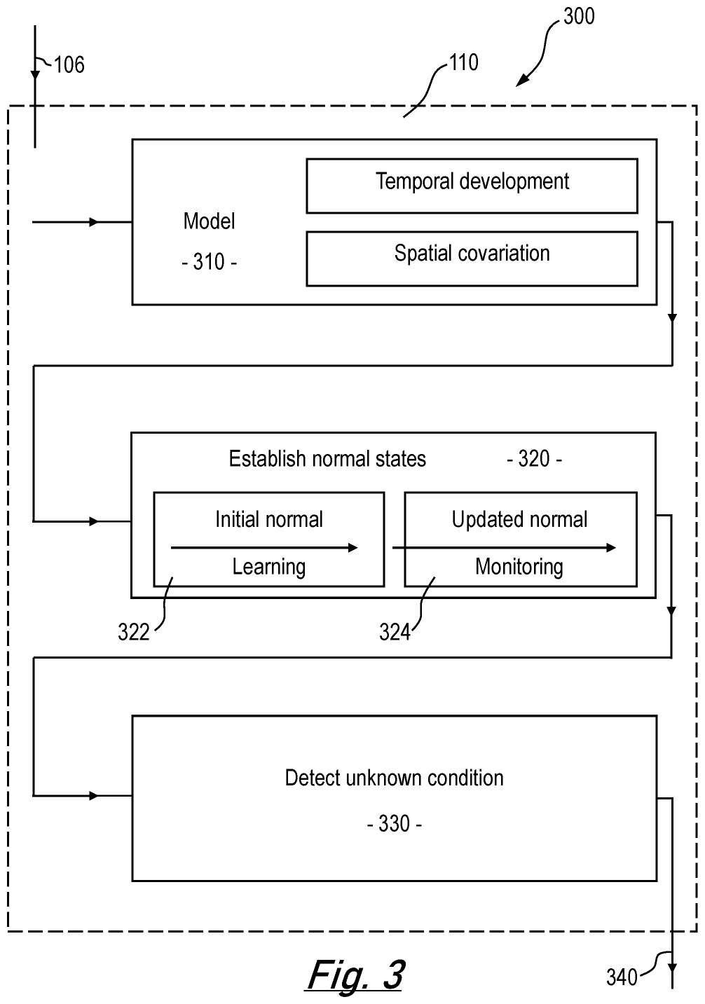

Referring now to FIG. 3, there is shown a flow diagram representing steps of a thermal video data analysis method used in embodiments of the invention. The method, generally depicted at 300, is carried out in the processing apparatus 110 of the monitoring system of FIG. 1, and is implemented in the software and hardware modules of FIG. 2.

The processing apparatus 110 receives the thermal video data stream 106 from the camera data capture interface 204. Using multivariate analysis techniques, the real-time data is used to build and optimise a model 310 of the behaviour of the thermal signature of the object. The model includes modelling of the temporal development, i.e. the changes in time, of the observed spatial heat distribution over the object being monitored. In addition, the model includes modelling of the covariation of the heat distribution between spatially different parts or regions of the object, or separate objects or units within the scene.

By modelling the covariation of different areas of the thermal video images in this way, sensitivity to changes in condition can be increased. For example, two measured positions on an object may be determined by the model to have a particular correlation. In some scenarios, the two measurement points will present thermal data that is within an expected range and corresponds to normal operating state when considered independently of one another. By making a comparison between the data from the two measured positions, small deviations from the modelled correlation between the respective data points are detectable, and may be detected as an unknown abnormal condition, that would have been otherwise undetected.

The models describing the object behaviour—including the changes in time and covariation between spatial areas—are optimised, and the optimised models are used to establish one or more normal states of the object (step 320). The normal states provide a baseline against which the real-time data will be compared in the detection of unknown or abnormal conditions (step 330).

During a learning phase 322, an initial normal state is established using observed data from the real-time thermal video data stream and the model 310, prior to a monitoring phase. With an initial normal state established, real-time thermal video data is compared against the initial normal state, and a deviation from the normal state is detected as an unknown condition or anomaly, generating a real-time alarm output 340 to the user interface along with visualisations of the thermal signature of the objects in real-time. The operator can check the alarm, and give feedback to the system. If the situation is to be considered as normal, this information can be used to update the set of normal states (324). If the situation is to be considered as an alarm state, information relating to the situation can be recorded together with a classifier or description for the alarm.

The applicant's International patent publication number WO 2018/111116, the content of which is incorporated herein by reference in its entirety, describes a general approach to processing large amounts of multidimensional data, using real-time multivariate analysis and pattern recognition techniques to generate self-developing models. The technique can be used generally in system monitoring applications and for compressed, efficient transmission of data files. WO 2018/111116 refers to processing input data from thermal cameras, but does not provide details on specific thermal video applications. The present inventors have appreciated that for effective application of the data analysis techniques of WO 2018/111116 to thermal video data monitoring, it is highly beneficial to the sensitivity of the system to model both the temporal development of an observed temperature mesh over the objects, and the covariation between different spatial areas.

A preferred embodiment of the invention uses the techniques described in WO 2018/111116 for establishing the model 310, compressing multi-dimensional data, and establishing normal states. The method is an inventive use and modification of the more general multivariate analysis techniques described in WO 2018/111116 in an application to thermal video monitoring.

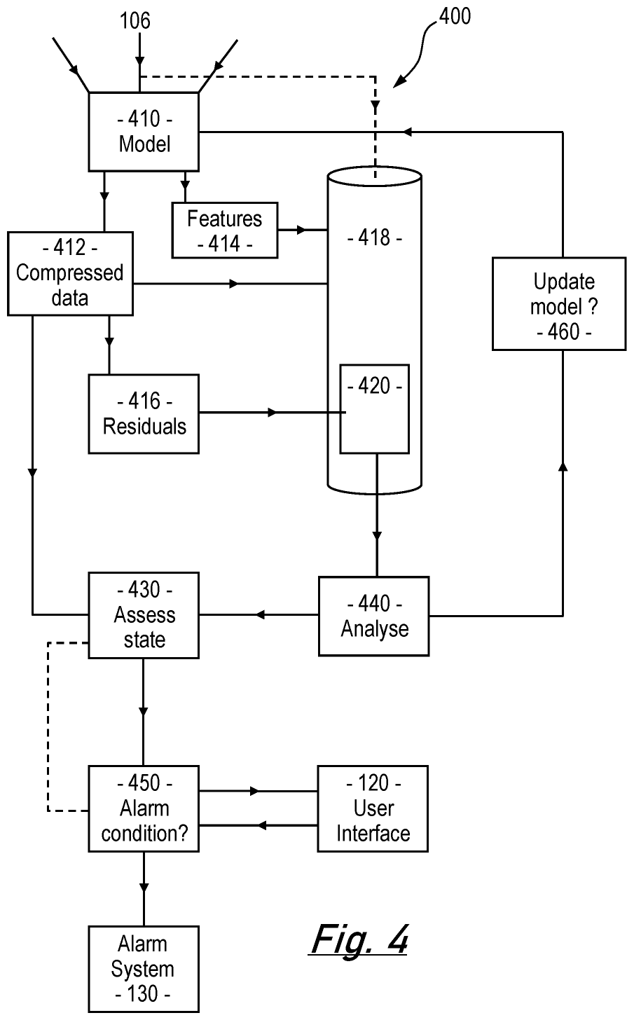

FIG. 4 is a flow diagram representing steps of a thermal video data monitoring method used in a preferred embodiment of the invention. The method, generally shown at 400, comprises a model 410 receiving an input thermal video data stream 106 in real-time from one or more thermal video cameras, and optionally additional data such as simulation model data and process data. Before data is input into the model, the consecutive stream of thermal images may be extended with new spatiotemporal representations, converting the single-channel temperature video into a multi-channel or “multi-spectral” video measuring system. One type of imaging extension is derived from the thermal image stream itself, for example in order to describe the spatiotemporal dynamics and to reveal spatiotemporal abnormalities. For example derivative images, difference images or smoothed images in the spatial and/or temporal domains reveal systematic spatiotemporal dynamics patterns in the object's surface temperatures. Another type of imaging extension is spatiotemporal data from other camera types, e.g. RGB, hyperspectral vis/NIR cameras, Radar or Lidar. Possible time delays between different sensors are estimated and corrected for.

The model 410 is a data-driven multivariate analysis model, generated from the thermal video data, and includes modelling of both the temporal development of an observed temperature mesh over the objects, and the covariation between different spatial areas, as described above. The model 410 incorporates pre-treatment or pre-processing steps, which include various mathematical operations. Examples include linearization, preliminary modelling, and signal conditioning, according to techniques that are known to one skilled in the art (for example as described in WO 2018/111116).

The outputs of the model are modelled data in the form of a compressed data stream 412, and output model features 414. The compressed data 412 is a lower-dimensional, compressed representation of the multichannel high dimensional real-time thermal mesh over the objects being monitored, calculated by reducing redundancy and replacing the high number of input variables with a comparatively low number of essential component variables that summarize the input data. The compressed data may be described as a projection of the real-time input data onto a subspace. The output model features 414 include loadings used in the model, or other model features that would enable the real-time data to be reproduced to a defined degree of precision from the compressed data.

Compressed data 412 and model features 414 are stored in long term and/or short term storage of the system.

The compressed data 412 is assessed against the established normal states (step 430) of the system being monitored, to establish whether the objects are in an alarm condition 430. Information and visualisations relating to the potential alarm condition are transmitted to the user interface 120, enabling an operator to make investigations and optionally provide feedback to the system to confirm the alarm condition and/or identify and categorise the condition. The calibrated real-time data is analysed to scan for unallowable temperatures under any conditions.

In parallel with the real-time alarm processing described above, residuals are calculated from real-time and compressed data (step 416). A residual of a multichannel data point represents the difference between the real-time input data point, and a reconstruction of the data point from the compressed data. The calculated residuals are stored in a residual data depository 420 in data storage 418 (optionally, insignificant residuals may be discarded rather than stored). At intervals during the method, residuals stored in the repository 420 are analysed (step 440) for the presence of systematic patterns of variation. The identification of new patterns is used to suggest new normal states of the object, to be used in the future detection of a possible alarm condition (430). The suggestion for new normality is validated by the users of the system before a new system baseline is established or rejected. The new set of normal states can also be used in the assessment of historical conditions, by comparison with previously compressed data recovered from the data storage.

Other measures that can be used to quantify and recognise a deviation from a normal state include changes to the underlying model, new data observations that does not match previous observations, outlier analysis, new values in trends, and observations or trends matching non-wanted behaviour. More details of such methods are described in WO 2018/111116, but can also include the use of multi-resolution histograms, Q-statistics, and/or other methods for determining if an observation falls inside the expected range of observations.

If a model update is considered necessary or preferable (or is otherwise scheduled to be performed) the process continues to step 460, in which the model 410 is updated to include a new loading in an expansion of the original model. Optionally, existing residuals are recalculated using the expanded model and replace those in the residual repository. In addition, updating of the model 410 may optionally include recentring, rescaling, and/or reorthogonalization of the model. Using these techniques, the model 410 is self-developing through its use in a real-time object monitoring application.

The above-described method can also be used in a learning phase, in which the model 410 is generated from an empty state, using the thermal video data stream before the system goes live to a monitoring phase in which alarm conditions are assessed. The model can grow by recognising systematic patterns of variation in the input data, while measurement errors and other non-systematic variation in the input data may be eliminated as statistical waste. This self-modelling capability facilitates the application of the system to monitoring objects with little or no pre-configuration or calibration. The system can be initialised without relying on a good fault-library, and instead can learn from new situations observed as deviations from the normal state, and which may be identified as new faults by user input.

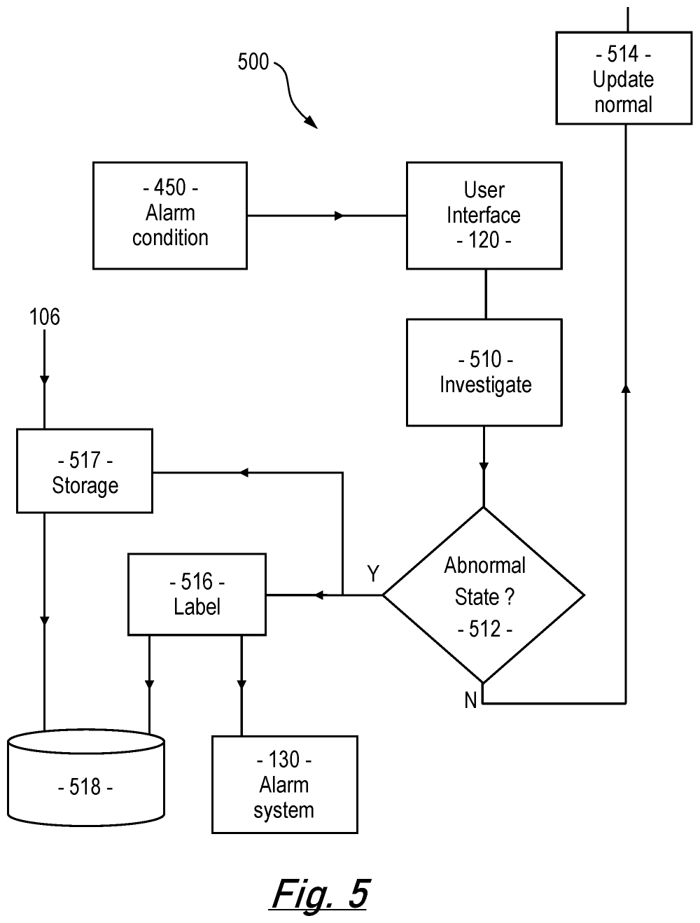

FIG. 5 is a flow diagram representing steps of a method of generating a fault library using the analysis methods according to an embodiment of the invention. The method, shown generally at 500, shows one manner in which an operator may use the system to develop a fault library that may be used to identify and categorise, alarm conditions, and generate an appropriate alarm signal. The methods 300 or 400 of FIGS. 3 and 4 are capable of producing a signal indicating a potential alarm condition 450, using the multivariate analysis approaches described herein. The potential alarm conditions 450 is communicated to an operator via the user interface 120, and the operator investigates the condition (step 510) to determine whether the condition is a normal operating condition of the objects or a genuine alarm condition (step 512).

Using a set of histograms, with different resolutions, the observations can be separated into different regions. Labelling such regions with operator knowledge about the underlying cause (e.g. a known fault, a sub-optimal set of operating conditions, or the optimal operating conditions) makes the situation recognizable. This enables fault identification, rather than fault detection. The multi-resolution approach also makes it possible to estimate the uncertainty of a fault.

A set of visualization models are also established to provide stable trends and references to the end user. Separating the system and visualization model allows the underlying system to accurately change with the data, without confusing the end user with constant shifts in the representation. The visual models can be compared, and new references can be established if there are significant changes in the object. Transformation between new and old references allow the history to be preserved. The thermal signature and differences between different points in time can be visualized using reconstructions from the compact representation. Drill-down analysis is also available through which the operators can investigate the model and its parameters.

If the condition is determined to be a normal operating condition, input from the operator can be used to update the set of normal states (step 514) used in the processing to assess future data points as potential alarm conditions.

If the condition is determined to be a genuine alarm condition, the operator can identify the fault, the condition data can be labelled with the fault information (516), and this information can be stored in a database (518) with the relevant compressed data. In addition, the uncompressed data from the real-time thermal video data stream 106 is written or otherwise linked to the database 518 from the short term storage 517.

Appropriate alarm signals can be generated using the alarm system 130. Automated event and alarm generation on key changes or changes outside of the accepted range are able to provide very concise alarms to the users. The events and alarms are supported by information about changes and the state before (and after) the occurrence of the alarm condition. These alarms account for normal variation in the temperature of the object being monitored (outside temperature, operating conditions) and will only trigger if the measurements deviate outside of the object baseline. This means that the alarms both can be robust and sensitive at the same time.

Alarms, change analysis, and other data output from the methodology can be used for control, inspection, maintenance, and safety related objectives. These include early intervention, replacement, or identification of parts for replacement, or identification of problematic behaviour. The visualization and analysis provide an operator with an understanding of alarm data, by visualizing why the alarm is given and the changes that caused the alarms. This can allow operators to have more confidence in why certain alarms should be ignored, or to understand the severity of an alarm.

Embodiments of the invention give significant HSE improvements by enabling accurate estimation of the state of an object or objects, enabling early warnings of dangerous situations, and by removing personnel that would normally perform manual inspection from hazardous environments. The methods do not depend on invasive installation or heavy manual calibration, but instead use a training process during which the object is observed. The data-driven approach and use of normal states or object baselines reduces the need for an extensive fault library before the system contributes to fault detection, all with little configuration.

The technology has many applications, including monitoring of electrical equipment, engines, pumps, furnaces, tanks, chemical reactors, ovens, pipes, heating or cooling systems, or similar objects. Common to the objects is that they have an observable thermal signature, where changes and developments over time can indicate underlying faults.

The foregoing description relates to use of the invention as an enhancement to current condition monitoring techniques, to provide continuous, automated fault detection, which may be used to identify and record fault conditions. The methodology is an improvement over that manual, spot checks that are performed in conventional condition monitoring. In addition, through its self-modelling and compact representation of the data, the methodology of the invention enables lifetime analysis of the system or object being monitored.

The thermal profile of the objects is compactly stored, and provides a history of system changes, including temporary changes that may not have been identified as an alarm condition, but which may cumulatively contribute to issues in the system. For example, the historical data can be used to quantify the thermal load experienced by an object over time. This enables improved maintenance through planned interventions, targeted inspection, and sub-system fault identification. Updates to the model and normal states of the system through the modelling development can also be reflected through the historical data, to provide a history of system changes and conditions that are representative of the complete knowledge of the developed models.

To quantify the thermal load due to temperature changes and/or due to operating for long periods at temperatures outside of an equipment envelope, data stored in historian module 252 are subject to trend analysis (module 253) for each identified part or region of the observed object, including statistical evaluation of curve integrals. A total life-time thermal load, thermal load outside normal operation, thermal load outside equipment limits, and other statistics regarding maximum and minimum temperatures and temperature increases are calculated. Further analysis identifies and alert operators to periods with large changes in thermal load.

The generated statistics are used to provide information and warnings about the thermal load over time, the change in thermal load, and to provide graphical representations of the thermal load for different parts via the web application 224 or other user interfaces 220. This can be used for maintenance planning or for targeted inspection in cases of extreme loads over longer or shorter periods. The generated statistics can also be exported from an API 260 to a data export for use by classification agencies or for use by e.g. insurance companies to evaluate the system condition, need for replacement, and for determining policy prices.

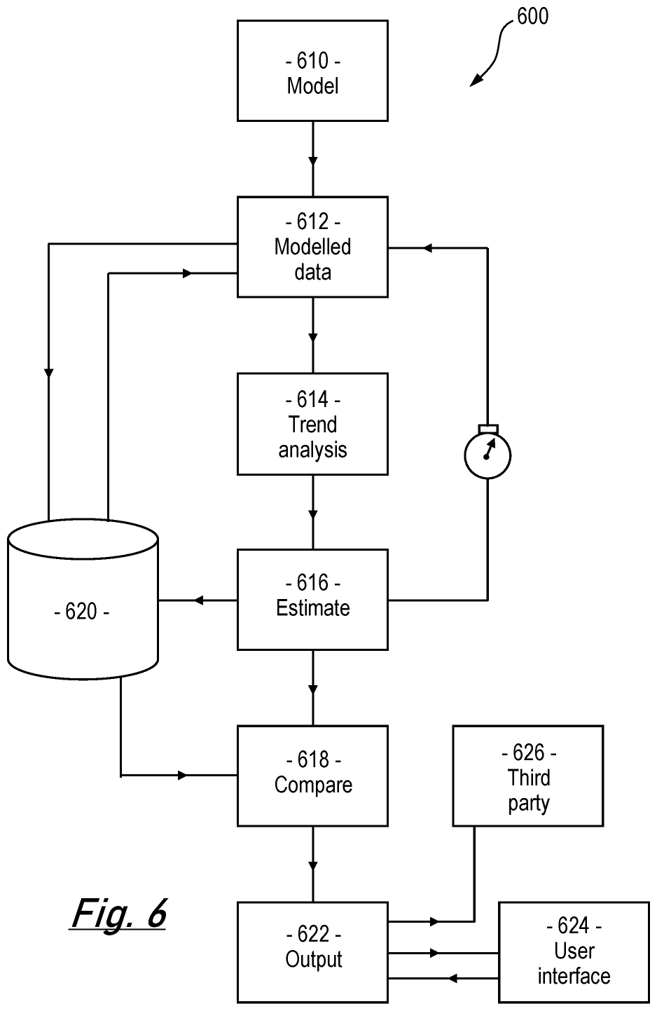

FIG. 6 is a flow diagram representing the steps of one method of quantifying the total thermal load of the object over the lifetime of an observation period. The method, generally shown at 600, generates a modelled data set from a thermal video data stream, using the data-driven multivariate analysis model 610. As with previous embodiments of the invention, the model 610 includes modelling of both the temporal development of an observed temperature mesh over the objects, and the covariation between different spatial areas. The model 610 incorporates optional pre-treatment or pre-processing steps. Modelled data 612 is stored in data storage 620.

At a point in time T₁, a trend analysis 614 is performed on the modelled data set 612, including historical modelled data retrieved from the data storage 620, to derive thermal trends which represent the thermal load of the system and the identified parts or subsystems. The output of the trend analysis is an estimate of the total thermal load 616 from the start of the observation period to the time T₁ (a first time interval). A comparison 618 is made with predetermined thresholds, and an output signal 622 is issued if the estimated total thermal load 616 over the first time interval exceeds a predefined limit.

At a second, later, time T₂, a trend analysis 614 is performed on a later modelled data set of thermal trends, up to and including measurements taken to time T₂, which represent the thermal load of the system to time T₂. The output 616 is therefore an estimate of the total thermal load from the start of the observation period to the time T₂ (a second time interval).

The estimated total thermal load over the second time interval is compared 618 to the estimated total thermal load over the previous, first time interval. An output signal is issued if the estimated total thermal load to time T₂ exceeds a predefined limit over the second time interval, or has increased by more than a predetermined threshold since the estimated total thermal load over the previous, first time interval.

The output signals 622 may include graphical representations of the thermal load for different parts of the system, and the user interfaces 624 enable alarm evaluation and operator feedback to the system. APIs enable exporting thermal load data to one or more third party or external software systems 626, for example, an insurance company or certification agency for verification of system integrity.

The thermal load can be estimated at regular intervals through a monitoring operation as described above, and/or can be estimated based on a selected modelled data set retrieved from the data storage. It will be appreciated that the method can be used to quantify thermal load due to temperature changes, thermal load due to operating for long periods at temperatures outside of an equipment envelope, or combinations of these effects.

In addition to the condition monitoring applications described above, the method can incorporate existing process data and process knowledge into the model. By integrating process data and/or process models from an existing system into the multivariate analysis, the monitoring methods can reveal state information that is informative for process optimisation or understanding.

The invention provides a method of and system for a method of monitoring an object using thermal video data. The method comprises capturing thermal video images of a scene comprising the object using one or more thermal imaging cameras, and outputting a thermal video data stream to a processing apparatus. In the processing apparatus, the thermal video data stream is processed by performing a multivariate analysis of the thermal video data stream to generate one or more models of the behaviour of the object. The one or more models includes modelling of temporal development of a thermal signature of the object, and modelling of covariation of the thermal signature between different parts or regions of the scene. The processing comprises establishing one or more normal states of the object using observed data from the thermal video data stream and the one or more models, and comparing observed data from the thermal video data stream with the one or more normal states of the object to determine whether the object is a known condition or an unknown condition. An output signal from the processing apparatus if the object is determined to be in an unknown condition.

The techniques described herein provide multivariate modelling and analysis of thermal video and (optionally) process data in a self-modelling system that establishes and updates normal states or object baselines. This enables detection and quantification of deviations from the normal states, and enables tracking and represent normal states over time. The techniques compress complex and big data streams. The techniques are transparent machine learning techniques with inspectable sub-systems and cause analysis. The system is inspectable at each level, allowing the user to drill-down and visualize model parameters, changes to models, and current and previous trends. Each alarm links back to the root-cause of the deviation and allows the user to inspect what changed between the previous points in time and the alarm.

The methodology includes automated detection of unconnected objects within a monitored scene (e.g. separation of unconnected engine parts, or different units), by modelling covariation between different spatial areas in a thermal mesh over the objects and its development in time. Complex video signals can be decomposed into individual thermal trends, and similarity matching between models of equipment of same type can be carried out.

Various modifications to the above-described embodiments may be made within the scope of the invention, and the invention extends to combinations of features other than those expressly claimed herein.

1. A method of monitoring an object or objects using thermal video data, the method comprising:
Capturing thermal video images of a scene comprising the object or objects using one or more thermal imaging cameras, and outputting a thermal video data stream to a processing apparatus;
In the processing apparatus, processing the thermal video data stream by:
performing a multivariate analysis of the thermal video data stream to generate one or more models of the behaviour of the object or objects, the one or more models including modelling of temporal development of a thermal signature of the object or objects, and modelling of covariation of the thermal signature between different parts or regions of the object or objects, or separate objects within the scene;
generating modelled data from the one or more models;
establishing one or more normal states of the object or objects using observed data from the thermal video data stream and the one or more models;
comparing modelled data with the one or more normal states of the object or objects to determine whether the object is in a known condition or in an unknown condition; and
Generating an output signal from the processing apparatus if the object or objects are determined to be in an unknown condition.

2. The method according to claim 1, wherein the modelled data comprises a compressed thermal video data sequence.

3. The method according to claim 1, comprising using the one or more models to represent observed data from the thermal video data in a subspace, the subspace being lower dimensional than the thermal video data stream.

4. The method according to claim 1, comprising inputting process data into the processing apparatus, the process data relating to a process utilising the object or objects, and incorporating the process data into the one or more models.

5. The method according to claim 1, comprising inputting simulation data into the processing apparatus, the simulation data relating to an estimation of the internal state of the object or objects, and incorporating the simulation data into the one or more models.

6. The method according to claim 1, comprising outputting one or more model features from the processing apparatus, and storing the model features in a data storage apparatus.

7. The method according to claim 6, wherein the model features comprise loadings used in the model.

8. The method according to claim 1, comprising extending the captured thermal images with additional spatiotemporal representations of the data to create a multi-channel or multispectral measurement video data stream.

9. The method according to claim 1, comprising storing uncompressed data from the thermal video data sequence in a data storage apparatus.

10. The method according to claim 1, comprising, during a learning phase, establishing one or more initial normal states using observed data from the thermal video data stream and the one or more models.

11. The method according to claim 10, wherein establishing one or more normal states of the object or objects comprises updating the one or more initial normal states during a monitoring phase, using the observed data from the thermal video data stream and the one or more models.

12. The method according to claim 1, comprising updating the one or more models by one or more of: adding more loadings to the existing set of models, adding new models to represent certain conditions, or changing loadings of the models.

13. The method according to claim 1, comprising generating an alarm signal to an operator from the output signal.

14. The method according to claim 1, comprising transmitting a signal that the object or objects are determined to be in an unknown condition to a user interface, and receiving an input from an operator that classifies the unknown condition of the object or objects as a normal state or an abnormal state.

15. The method according to claim 1, comprising categorising and/or labelling the abnormal state with a fault label.

16. A method of analysing thermal video data, the method comprising:
Receiving in a processing apparatus a thermal video data stream, the thermal video data stream comprising a sequence of thermal video images of a scene comprising an object or objects captured using one or more thermal imaging cameras;
In the processing apparatus, processing the thermal video data stream by:
performing a multivariate analysis of the thermal video data stream to generate one or more models of the behaviour of the object or objects, the one or more models including modelling of temporal development of a thermal signature of the object or objects, and modelling of covariation of the thermal signature between different parts or regions of the object or objects, or separate objects within the scene;
generating modelled data from the one or more models;
establishing one or more normal states of the object or object using observed data from the thermal video data stream and the one or more models;
comparing modelled data with the one or more normal states of the object to determine whether the object is in a known condition or in an unknown condition; and
Generating an output signal from the processing apparatus if the object or objects are determined to be in an unknown condition.

17. A method of assessing the thermal load of an object or objects from thermal video images, the method comprising:
Receiving in a processing apparatus a data set from a data storage apparatus, the data set comprising modelled data generated by:
processing a thermal video data stream comprising a sequence of thermal video images of a scene comprising an object or objects captured using one or more thermal imaging cameras; and
generating the modelled data from the thermal video data stream using one or more models, the one or more models including modelling of temporal development of a thermal signature of the object or objects, and modelling of covariation of the thermal signature between different parts or regions of the object or objects, or separate objects within the scene;
wherein the modelled data comprises a compressed thermal video data sequence;
In the processing apparatus, analysing the data set by:
performing an analysis of thermal trends representing the thermal load of the system to estimate the total thermal load over a time interval; and
issuing an output signal if the total thermal load exceeds a predefined limit or has increased by more than a predefined amount over a specified time window.

18. The method according to claim 17, comprising using the one or more models to represent observed data from the thermal video data in a subspace, the subspace being lower dimensional than the thermal video data stream.

19. The method according to claim 17, comprising outputting one or more model features from the processing apparatus, and storing the model features in a data storage apparatus.

20. The method according to claim 19, wherein the model features comprise loadings used in the model.

21. The method according to claim 17, comprising storing uncompressed data from the thermal video data sequence in the data storage apparatus.

22. The method according to claim 17, comprising generating a representation of the total thermal load, and transmitting the representation to a user interface.

23. The method according to claim 17, the method comprising comparing the estimated total thermal load over the time interval with an estimated total thermal load over an earlier time window, and issuing an output signal if the estimated total thermal load has increased by more than a predefined amount from the estimated total thermal load over the earlier time window.

24. The method according to claim 17, wherein the method is implemented in a system comprising one or more Application Programming Interfaces (APIs), and the method comprises exporting thermal load data to one or more third party or external software system.

25. An apparatus configured to carry out the method of claim 1.

26. A computer readable medium carrying computer executable instructions capable of enabling a processing apparatus to perform the method of claim 1.
